(19) United States
(12) Patent Application Publication
(10) Pub. No.: US 2007/0064191 A1
(43) Pub. Date: Mar. 22, 2007

(54) Liquid crystal display

(75) Inventors: Kyoung-Ju Shin, Yongin-si (KR); Hak-Sun Chang, Yongin-si (KR); Hyun-Wuk Kim, Busan (KR); Yeon-Ju Kim, Suwon-si (KR)

Correspondence Address: F. CHAU & ASSOCIATES, LLC, 130 WOODBURY ROAD, WOODBURY, NY, 11797, US

(73) Assignee: Samsung Electronics Co.,LTD., Suwon-si (KR)

(21) Appl. No.: 11/503,805

(22) Filed: Aug. 14, 2006

(30) Foreign Application Priority Data
Aug. 16, 2005 (KR) 10-2005-0074959

(51) Int. Cl. G02F 1/1343

(52) U.S. Cl. 349/144

(57) ABSTRACT

A liquid crystal display includes a substrate, a plurality of first subpixel electrodes disposed on the substrate, each of the first subpixel electrodes having a pair of bent edges substantially parallel to each other, a plurality of second subpixel electrodes disposed on the substrate, each of the second subpixel electrodes having a pair of bent edges substantially parallel to each other, each pair of the first and the second subpixel electrodes disposed in a first direction and forming a pixel electrode, and a common electrode facing a plurality of pixel electrodes including the pixel electrode, wherein the first and the second subpixel electrodes have different lengths in a second direction substantially perpendicular to the first direction.

### CROSS-REFERENCE TO RELATED APPLICATION

This application claims priority to and the benefit of Korean Patent Application No. 10-2005-0074959 filed in the Korean Intellectual Property Office on Aug. 16, 2005, the entire contents of which are incorporated herein by reference.

### BACKGROUND OF THE INVENTION

(a) Field of the Invention

The present invention relates to a liquid crystal display.

(b) Description of Related Art

Liquid crystal displays (LCDs) are one of the most widely used flat panel display devices. An LCD includes a pair of panels, each having field-generating electrodes such as pixel electrodes or a common electrode, and a liquid crystal (LC) layer interposed between the panels. The LCD generates an electric field in the LC layer by applying voltages to the electrodes, and obtains desired images by controlling the strength of the electric field to change an orientation of LC molecules, polarize light incident on the LC layer, and vary the transmittance of the light incident on the LC layer.

The LCD further includes switching elements connected to the pixel electrodes and signal lines such as gate lines and data lines for applying signals to the switching elements, thereby applying voltages to the pixel electrodes.

Among the LCDs, a vertical alignment (VA) mode LCD, which aligns LC molecules such that the long axes of the LC molecules are perpendicular to the panels in absence of electric field, achieve a high contrast ratio and a wide reference viewing angle. The reference viewing angle is a viewing angle where the contrast ratio is about 1:10 or the luminance sequence of grays starts to be reversed.

The wide viewing angle of the VA mode LCD can be realized by cutouts in the field-generating electrodes and protrusions on or under the field-generating electrodes. Since the cutouts and the protrusions can determine the orientation of tilt angle of the LC molecules, the tilt angles can be distributed into several directions by using the cutouts and the protrusions to widen the reference viewing angle.

The protrusions and the cutouts may obstruct the transmission of incident light and thus, the light transmittance decreases as the number of the protrusions or the cutouts increases. To increase the light transmittance, the area of the pixel electrodes may be enlarged. An enlarged pixel electrode needs to be disposed closer to adjacent pixel electrodes and the data lines such that strong lateral electric fields are generated near edges of the pixel electrodes. The lateral electric fields effect the orientations of the LC molecules to generate texture and light leakage and elongate a response time of an affected pixel.

In addition, the VA mode LCD has poor lateral visibility as compared with front visibility. For example, in a conventional LCD provided with cutouts, the image becomes bright as it goes to lateral edges of the LCD and in a severe case, the luminance difference between high grays vanishes to make the image dim.

### SUMMARY OF THE INVENTION

A liquid crystal display according to an embodiment of the present invention includes a substrate, a plurality of first subpixel electrodes disposed on the substrate, each of the first subpixel electrodes having a pair of bent edges substantially parallel to each other; a plurality of second subpixel electrodes disposed on the substrate, each of the second subpixel electrodes having a pair of bent edges substantially parallel to each other, each pair of the first and the second subpixel electrodes disposed in a first direction and forming a pixel electrode, and a common electrode facing a plurality of pixel electrodes including the pixel electrode, wherein the first and the second subpixel electrodes have different lengths in a second direction substantially perpendicular to the first direction.

One of the bent edges of the first subpixel electrode and one of the bent edges of the second subpixel electrode in each of the pixel electrodes may be aligned with each other in the first direction. Otherwise, a center of the first subpixel electrode and a center of the second subpixel electrode in each of the pixel electrodes may be aligned with each other in the first direction.

The liquid crystal display may further include: a plurality of thin film transistors coupled to the pixel electrodes; a plurality first signal lines coupled to the thin film transistors and spaced apart from each other by a substantially uniform distance in the first direction; and a plurality of second signal lines coupled to the thin film transistors and intersecting the first signal lines.

The first signal lines may transmit data voltages and may be rectilinear.

Each of the first and the second subpixel electrodes may be coupled to one of the thin film transistors, and the first and the second subpixel electrodes in each of the pixel electrodes may be supplied with different data voltages originated from a single image information. The first and the second subpixel electrodes are supplied with respective data voltages at different times or substantially at substantially the same time.

The second signal lines may pass through the first subpixel electrodes or the second subpixel electrodes or may extend along boundaries of the first subpixel electrodes and the second subpixel electrodes.

The liquid crystal display may further include an organic layer disposed between the pixel electrodes and the thin film transistors and the first and the second signal lines.

The liquid crystal display may further include a plurality of storage electrode lines overlapping at least one of the first subpixel electrodes and the second subpixel electrodes and either passing through the first or the second subpixel electrodes or extending along boundaries of the first subpixel electrodes and the second subpixel electrodes.

The bent angles of the bent edges of the first and the second subpixel electrodes may be substantially equal to a right angle.

The first subpixel electrodes and the second subpixel electrodes may have substantially the same length in the first direction. A length of the second subpixel electrodes may be from about 1.8 times to about twice a length of the first subpixel electrodes in the second direction.

The first subpixel electrode and the second subpixel electrode in each of the pixel electrodes may be separated from each other and may have separate voltages. The area of the first subpixel electrode may be smaller than the second subpixel electrode, and the voltage of the first subpixel electrode may be higher than the voltage of the second subpixel electrode. In particular, the area of the second subpixel electrode may be from about 1.8 times to about twice the area of the first subpixel electrode.

The first subpixel electrode and the second subpixel electrode in each of the pixel electrodes may be supplied with separated data voltages originated from a single image information. Alternatively, the first subpixel electrode and the second subpixel electrode in each of the pixel electrodes may be capacitively coupled to each other, or may be directly connected to each other.

### BRIEF DESCRIPTION OF THE DRAWINGS

The present invention will become more apparent by describing embodiments thereof in detail with reference to the accompanying drawings in which:

FIG. 1 is a block diagram of an LCD according to an embodiment of the present invention;

FIG. 2 is an equivalent circuit diagram of a pixel of an LCD according to an embodiment of the present invention;

FIG. 3 is a layout diagram of pixel electrodes, a common electrode, color filters, and data lines in an LC panel assembly according to an embodiment of the present invention;

FIG. 4 is a planar view of a base electrode forming a subpixel electrode shown in FIG. 3;

FIGS. 5 and 6 schematically show pixel electrodes and data lines according to embodiments of the present invention;

FIGS. 7A and 7B are equivalent circuit diagrams of signal lines and a pixel according to embodiments of the present invention.

FIG. 8 is a layout view of an LC panel assembly according to an embodiment of the present invention;

FIGS. 9 and 10 are sectional views of the LC panel assembly shown in FIG. 8 taken along lines IX-IX and X-X, respectively;

FIG. 11 is a layout view of an LC panel assembly according to another embodiment of the present invention;

FIG. 12 is an equivalent circuit diagram of signal lines and a pixel according to another embodiment of the present invention.

FIGS. 13, 14 and 15 are layout views of pixel electrodes and cutouts of LC panel assemblies according to other embodiments of the present invention; and

FIGS. 16 and 17 are layout views of an LC panel assembly according to other embodiments of the present invention.

### DETAILED DESCRIPTION OF PREFERRED EMBODIMENTS

The present invention now will be described more fully hereinafter with reference to the accompanying drawings, in which preferred embodiments of the invention are shown. The present invention may, however, be embodied in many different forms and should not be construed as limited to embodiments set forth herein.

In the drawings, the thickness of layers, films and regions are exaggerated for clarity. Like numerals refer to like elements throughout. It will be understood that when an element such as a layer, film, region or substrate is referred to as being “on” another element, it can be directly on the other element or intervening elements may also be present. In contrast, when an element is referred to as being “directly on” another element, there are no intervening elements present.

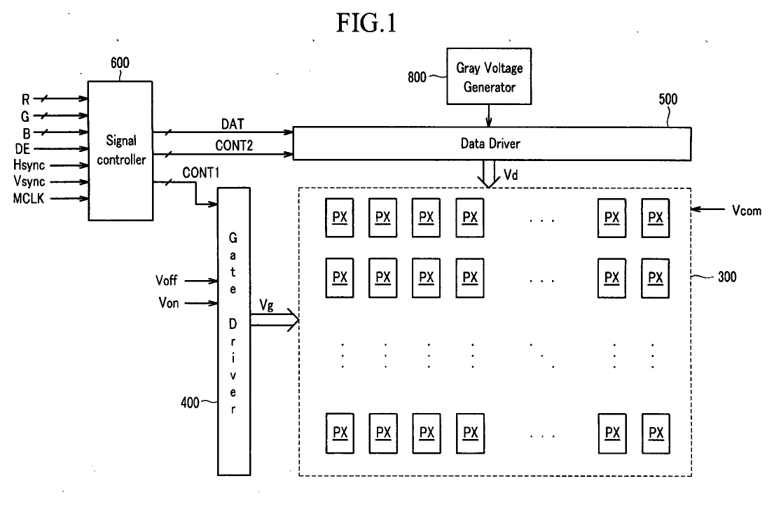

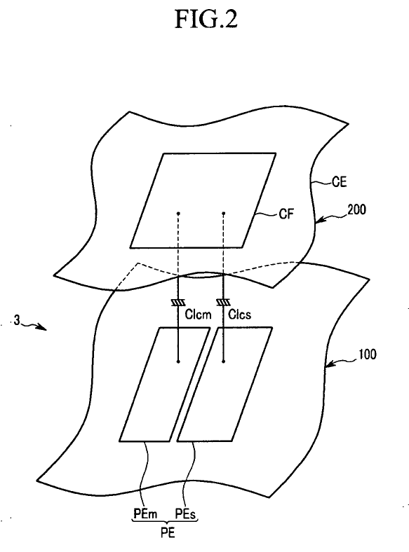

An LCD according to an embodiment of the present invention will be described in detail with reference to FIGS. 1 and 2.

FIG. 1 is a block diagram of an LCD according to an embodiment of the present invention, and FIG. 2 is an equivalent circuit diagram of a pixel of an LCD according to an embodiment of the present invention.

Referring to FIG. 1, an LCD according to an embodiment includes an LC panel assembly 300, a gate driver 400, a data driver 500, a gray voltage generator 700, and a signal controller 600.

Referring to FIG. 1, the panel assembly 300 includes a plurality of signal lines (not shown) and a plurality of pixels PX connected thereto and arranged substantially in a matrix. In a structural view shown in FIG. 2, the panel assembly 300 includes a lower panel 100, an upper panel 200, and an LC layer 3 interposed therebetween.

The signal lines, which are provided on the lower panel 100, include a plurality of gate lines (not shown) transmitting gate signals (also referred to as “scanning signals”), and a plurality of data lines (not shown) transmitting data signals. The gate lines extend substantially in a row direction and are arranged substantially parallel to each other, while the data lines extend substantially in a column direction and are arranged substantially parallel to each other.

Referring to FIG. 2, each pixel PX includes a pair of subpixels and each subpixel includes a liquid crystal (LC) capacitor Clcm/Clcs. At least one of the two subpixels further includes a switching element (not shown) connected to a gate line, a data line, and an LC capacitor Clcm/Clcs.

The LC capacitor Clcm/Clcs includes a subpixel electrode PEm/PEs and a common electrode CE provided on an upper panel 200 as two terminals. The LC layer 3 disposed between the electrodes PEm/PEs and CE functions as dielectric of the LC capacitor Clcm/Clcs. The pair of subpixel electrodes PEm and PEs are separated from each other and form a pixel electrode PE. The common electrode CE is supplied with a common voltage Vcom and covers an entire surface of the upper panel 200. The LC layer 3 has negative dielectric anisotropy, and LC molecules in the LC layer 3 may be oriented so that long axes of the LC molecules are perpendicular to the surfaces of the panels 100 and 200 in absence of an electric field.

For color display, each pixel PX uniquely represents a primary color, wherein a spatial division separates colors, or each pixel PX sequentially represents the primary colors in turn, wherein a temporal division separates colors, such that a spatial or temporal sum of the primary colors are recognized as a desired color. While the primary colors includes red, green, and blue colors, the pixels PX may represent colors other than the primary colors. FIG. 2 shows an example of a spatial division in that each pixel PX includes a color filter CF representing one of the primary colors in an area of the upper panel 200 facing the pixel electrode PE. Alternatively, the color filter CF is provided on or under the subpixel electrode PEm or PEs on the lower panel 100.

A pair of polarizers (not shown) are attached to outer surfaces of the panels 100 and 200. The polarization axes of the two polarizers may be crossed such that the crossed polarizers block the light incident onto the LC layer 3. One of the polarizers may be omitted.

Referring to FIG. 1 again, the gray voltage generator 700 generates a plurality of gray voltages related to the transmittance of the pixels PX. The gray voltage generator 700 may generate only a given number of gray voltages (referred to as reference gray voltages) instead of generating all of the gray voltages.

The gate driver 400 is connected to the gate lines of the panel assembly 300 and synthesizes the gate-on voltage Von and the gate-off voltage Voff from an external device to generate gate signals Vg for application to the gate lines.

The data driver 500 is connected to the data lines of the panel assembly 300 and applies data voltages Vd, which are selected from the gray voltages supplied from the gray voltage generator 700, to the data lines. The data driver 500 may generate gray voltages for all the grays by dividing the reference gray voltages and select the data voltages Vd from the generated gray voltages when the gray voltage generator 700 generates reference gray voltages.

The signal controller 600 controls the gate driver 400 and the data driver 500.

Each of the driving units 400, 500, 600, and 700 may include at least one integrated circuit (IC) chip mounted on the LC panel assembly 300 or on a flexible printed circuit (FPC) film in a tape carrier package (TCP) type, which are attached to the panel assembly 300. Alternately, at least one of the processing units 400, 500, 600, and 700 may be integrated into the panel assembly 300 along with the signal lines and the switching elements. Alternatively, all the processing units 400, 500, 600, and 700 may be integrated into a single IC chip, but at least one of the processing units 400, 500, 600, and 700 or at least one circuit element in at least one of the processing units 400, 500, 600, and 700 may be disposed out of the single IC chip.

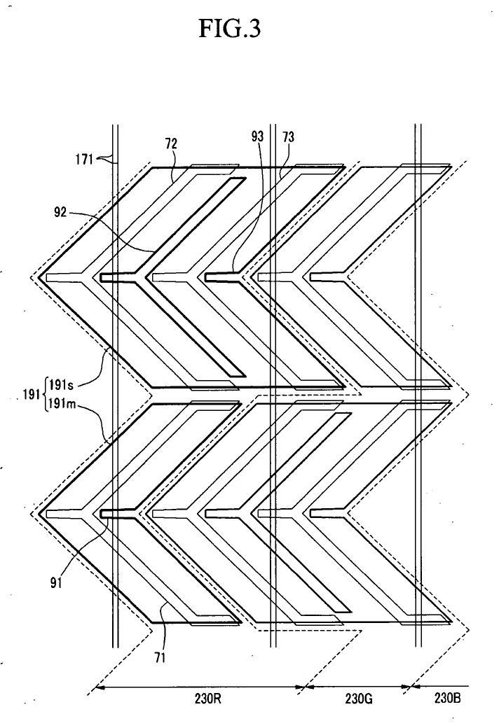

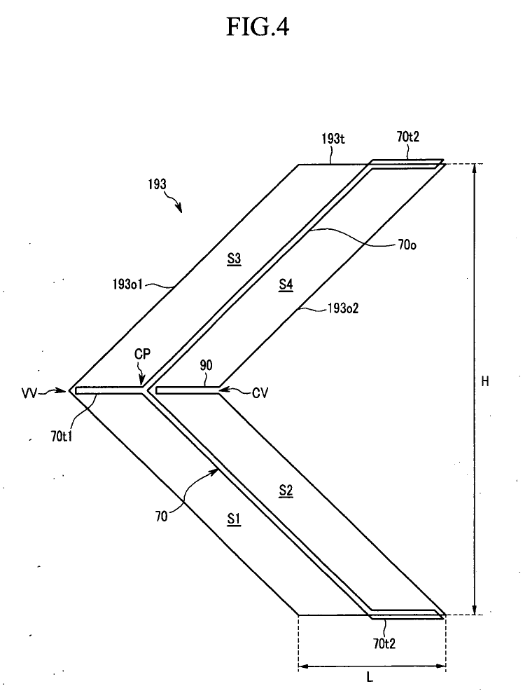

Detailed structures of pixel electrodes, a common electrode, color filters, and data lines in an LC panel assembly will be described in detail with reference to FIGS. 3 and 4.

FIG. 3 is a layout diagram of pixel electrodes, a common electrode, color filters, and data lines in an LC panel assembly according to an embodiment of the present invention, and FIG. 4 is a planar view of a base electrode forming a subpixel electrode shown in FIG. 3.

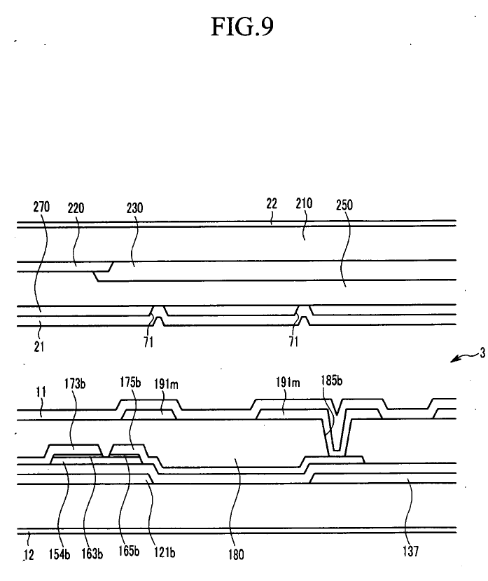

Referring to FIGS. 3 and 4, each pixel electrode 191 of the LC panel assembly includes a first subpixel electrode 191m and a second subpixel electrode 191s that are separated from each other and adjacent to each other in a column direction. The subpixel electrodes 191m and 191s have cutouts 91, 92 and 93. A common electrode 270 (see FIG. 9 and CE as shown in FIG. 2) has a plurality of cutouts 71, 72 and 73 facing the subpixel electrodes 191m and 191s. Red color filters 230R, green color filters 230G, and blue color filters 230B are formed adjacent to one another and extend along the pixel electrodes 191 the column direction.

Both of the first and the second subpixel electrodes 191m and 191s forming a pixel electrode 191 may be coupled to respective switching elements (not shown). Alternatively, the first subpixel electrode 191m is coupled to a switching element (not shown), while the second subpixel electrode 191s is capacitively coupled to the first subpixel electrode 191m. Each of the switching elements may be connected to a gate line and a data line. Reference numeral 171 denotes data lines.

Each of the subpixel electrodes 191m and 191s has a shape that is substantially the same as a base electrode 193 shown in FIG. 4 or has a shape where a pair of a base electrodes 193 adjacent in a row direction are connected to each other at upper and lower ends, etc. Each of the cutouts 71-73 in the common electrode 270 has substantially the same shape as a cutout 70 shown in FIG. 4. The arrangements of the subpixel electrodes 191m and 191s and the cutouts 71-73 and 91-93 are obtained by repeating the arrangement of the base electrode 193 and the cutout 70 in the row and column directions.

As shown in FIG. 4, the base electrode 193 has a pair of bent edges 193o1 and 193o2 and a pair of transverse edges 193t and has a shape of a chevron. The bent edges 193o1 and 193o2 includes a convex edge 193o1 meeting the transverse edges 193t at an obtuse angle, for example, about 135 degrees, and a concave edge 193o2 meeting the transverse edges 193t at an acute angle, for example, about 45 degrees. The bent edges 193o1 and 193o2, which are formed by the 90-degree meeting of a pair of oblique edges, have a bent angle of about a right angle. Each of the base electrodes 193 has a cutout 90 that extends from a concave vertex CV on the concave edge 193o2 toward a convex vertex VV on the convex edge 193o1 and reaches near a center of the base electrode 193.

The cutout 70 in the common electrode 270 includes a bent portion 70o having a bent point CP, a center transverse portion 70t1 connected to the bent point CP of the bent portion 70o, and a pair of terminal transverse portions 70t2 connected to ends of the bent portion 70o. The bent portion 70o of the cutout 70 includes a pair of oblique portions meeting at about a right angle, extends substantially parallel to the bent edges 193o1 and 493o2 of the base electrode 193, and bisects the base electrode 193 into left and right halves. The center transverse portion 70t1 of the cutout 70 makes an obtuse angle, for example, about 135 degrees with the bent portion 70o, and extends toward the convex vertex VV of the base electrode 193. The terminal transverse portions 70t2 are aligned with the transverse edges 193t of the base electrode 193 and make an obtuse angle, for example, about 135 degrees with the bent portion 70o.

The base electrode 193 is divided into four sub-areas S1, S2, S3 and S4 by the cutouts 70 and 90. Each of the sub-areas S1-S4 has two primary edges defined by a bent portion 70o of the cutout 70 and by a bent edge 193o of the base electrode 193. The distance between the primary edges, i.e., the width of each of the sub-areas S1-S4, may be equal to about 22-26 microns.

The base electrode 193 and the cutout 70 has an inversion symmetry with respect to an imaginary straight line (referred to as a center transverse line) connecting the convex vertex VV and the concave vertex CV of the base electrode 193.

As shown in FIG. 3, the second subpixel electrode 191s has a shape where two base electrodes 193 are connected at upper and lower ends thereof so that the concave edge of one of the two base electrodes 193 may neighbor the convex edge of the other of the two base electrodes 193. A gap between the two base electrodes 193 and a cutout 90 meeting the gap form the cutout 92. The cutout 92 includes a bent portion bisecting the second subpixel electrode 191s into left and right halves and a transverse portion meeting the bent portion.

Referring to FIG. 4, the length L of a transverse edge 193t of the base electrode 193 is defined as the length of the base electrode 193, and the distance H between the two transverse edges 193t of the base electrode 193 is defined as the height of the base electrode 193. The length and the height of a subpixel electrode including a base electrode 193 are defined in the above-described manner. In FIG. 3, the height of the first subpixel electrode 191m is substantially equal to the height of the second subpixel electrode 191s, and the length of the second subpixel electrode 191s is about 1.8-2 times the length of the first subpixel electrode 191m. Accordingly, the area of the second subpixel electrode 191s is about 1.8-2 times the area of the first subpixel electrode 191m.

The first subpixel electrode 191m and the second subpixel electrode 191s are alternately arranged in the row and column directions.

Regarding the arrangement of the subpixel electrodes 191m and 191s in the row direction, the center transverse line of the first subpixel electrode 191m coincides with the center transverse line of the second subpixel electrode 191s. The convex edge of the first subpixel electrode 191m neighbors the concave edge of the second subpixel electrode 191s, and the concave edge of the first subpixel electrode 191m neighbors the convex edge of the second subpixel electrode 191s.

Regarding the arrangement in the column direction, since the lengths of the first and the second subpixel electrodes 191m and 191s are different, several arrangements may be considered. One exemplary arrangement is to make a bent edge of one of the subpixel electrodes 191m and 191s meet a bent edge of the other of the subpixel electrodes 191s and 191m. In an example shown in FIG. 3, the convex edges (left edges) and the concave edges (right edges) of the first subpixel electrode 191m and the second subpixel electrode 191s are alternately aligned. Another exemplary arrangement is to deviate the bent edges of one of the two subpixel electrodes 191m and 191s from the bent edges of the other of the two subpixel electrodes 191s and 191m. For example, the first subpixel electrode 191m may be aligned with a center of the second subpixel electrode 191s.

In detail, in the example shown in FIG. 3, the convex edge of the first subpixel electrode 191m is substantially aligned to the convex edge of the second subpixel electrode 191s or to the bent portion of the cutout 92 bisecting the second subpixel electrode 191s, and the concave edge of the first subpixel electrode 191m is substantially aligned to the bent portion of the cutout 92 of the second subpixel electrode 191s or to the concave edge of the second subpixel electrode 191s. The bent portions of the subpixel electrodes 191m and 191s or the bent portions of the cutouts in adjacent subpixel columns are substantially aligned to each other, and the bent portions of the cutouts 71-73 of the common electrode 270 in adjacent subpixel columns are substantially aligned to each other.

The operation of the above-described LCD shown in FIGS. 1-4 will be described in detail.

The signal controller 600 is supplied with input image signals R, G and B, and input control signals controlling the display thereof from an external graphics controller (not shown). The input image signals R, G and B contain luminance information of each pixel PX, and the luminance has a predetermined number of grays, for example 1024(=2¹⁰), 256(=2⁸) or 64(=2⁶). The input control signals include a vertical synchronization signal Vsync, a horizontal synchronization signal Hsync, a main clock MCLK, a data enable signal DE, etc.

The signal controller 600 generates gate control signals CONT1 and data control signals CONT2 and processes the input image signals R, G and B suitable for the operation of the panel assembly 300 and the data driver 500 on the basis of the input control signals and the input image signals R, G and B. The signal controller 600 transmits the gate control signals CONT1 to the gate driver 400, and processed image signals DAT and the data control signals CONT2 to the data driver 500. The processed image signals DAT are digital signals having the predetermined number of values (or grays).

The gate control signals CONT1 include a scanning start signal STV for instructing the gate driver 400 to start scanning and at least a clock signal for controlling the output time of the gate-on voltage Von. The gate control signals CONT1 may further include an output enable signal OE for defining the duration of the gate-on voltage Von.

The data control signals CONT2 include a horizontal synchronization start signal STH for informing the data driver 500 of a start of data transmission for a group of subpixels, a load signal LOAD for instructing the data driver 500 to apply the data voltages to the panel assembly 300, and a data clock signal HCLK. The data control signal CONT2 may further include an inversion signal RVS for reversing the polarity of the data voltages with respect to the common voltage Vcom.

Responsive to the data control signals CONT2 from the signal controller 600, the data driver 500 receives a packet of the image data DAT for the group of subpixels from the signal controller 600. The data driver 500 converts the image data DAT into analog data voltages selected from the gray voltages supplied from the gray voltage generator 700, and applies the data voltages to the data lines.

The gate driver 400 applies the gate-on voltage Von to the gate line in response to the gate control signals CONT1 from the signal controller 600, thereby turning on the switching elements connected thereto. The data voltages applied to the data lines are supplied to the subpixels through turned on switching elements.

Referring to FIG. 3, when the first subpixel electrode 191m and the second subpixel electrode 191s forming a pixel electrode 191 are coupled to respective switching elements, e.g., when each of the subpixels includes its own switching element, the two subpixels may be supplied with respective data voltages Vd at different times through the same data line or through different data lines, or at the same time through different data lines.

When the first subpixel electrode 191m is coupled to a switching element (not shown) and the second subpixel electrode 191s is capacitively coupled to the first subpixel electrode 191m, one subpixel including the first subpixel electrode 191m may be directly supplied with data voltages Vd through the switching element, while the other subpixel including the second subpixel electrode 191s may have a voltage that varies depending on the voltage of the first subpixel electrode 191m. The first subpixel electrode 191m having a relatively small area preferably has a voltage (relative to the common voltage) greater than the second subpixel electrode 191s having a relatively large area.

When the voltage difference is generated between two terminals of the LC capacitor Clcm/Clcs, a primary electric field substantially perpendicular to the surfaces of the panels 100 and 200 is generated in the LC layer 3. Both the pixel electrodes PE and the common electrode CE are commonly referred to as field generating electrodes. The LC molecules in the LC capacitor Clcm/Clcs tend to change their orientations in response to the electric field so that their long axes may be perpendicular to the field direction. The molecular orientations determine the polarization of light passing through the LC layer 3. The polarizer(s) passes light having a certain polarization, passed light results in the light transmittance such that the pixels PX display the luminance represented by the image signal DAT.

The tilt angle of the LC molecules depends on the strength of the electric field. Since the voltages of the LC capacitors Clcm and Clcs are different from each other, the tilt angles of the LC molecules in the subpixels may be different from each other and thus the luminance of the two subpixels may be different from each other. Accordingly, the voltages of the two LC capacitors Clcm and Clcs can be adjusted so that an image viewed from a lateral side approaches the image viewed from the front, wherein, a lateral gamma curve approaches the front gamma curve. Lateral visibility improves as the lateral gamma curve approaches the front gamma curve.

In addition, the area of the first subpixel electrode 191m having a voltage (relative to the common voltage Vcom) higher than that of the second subpixel electrode 191s may have an area smaller than that of the second subpixel electrode 191s, thereby making the lateral gamma curve further approach the front gamma curve. In particular, when the ratio of the areas of the first subpixel electrode 191m and the second subpixel electrode 191s is equal to about 1:2, the lateral gamma curve further approaches the front gamma curve.

The tilt direction of the LC molecules is determined by a horizontal field component. The horizontal field component is generated by the cutouts 71-73 and 91-93 of the field generating electrodes 191 and 270 and the edges of the subpixel electrodes 191m and 191s, which distort the primary electric field. The horizontal field component is substantially perpendicular to the edges of the cutouts 71-73 and 91-93, and the edges of the subpixel electrodes 191m and 191s.

Referring to FIG. 3, since the LC molecules on each of the sub-areas divided by the cutouts 71-73 and 91-93 tilt perpendicular to the primary edges of the sub-area, the azimuthal distribution of the tilt directions are localized to four directions, thereby increasing the reference viewing angle of the LCD.

The width of the sub-areas, i.e., the distance between the oblique portions of the cutouts 71-73 of the common electrode 270 and the oblique edges of the subpixel electrodes 191m and 191s or the distance between the cutouts 91-93 is preferably equal to about 22-26 microns such that the horizontal component of the primary electric field can be suitably used and the decrease of the aperture ratio caused by the cutouts 71-73 and 91-93 can be reduced.

The direction of a secondary electric field due to the voltage difference between adjacent pixel electrodes 191 is perpendicular to the primary edges of the sub-areas. Accordingly, the field direction of the secondary electric field coincides with that of the horizontal component of the primary electric field. Consequently, the secondary electric field between the adjacent pixel electrodes 191 enhances the determination of the tilt directions of the LC molecules.

By repeating this procedure during each horizontal period (which is denoted by “1H” and equal to one period of the horizontal synchronization signal Hsync or the data enable signal DE), all the pixels PX are supplied with data voltages.

When the next frame starts after one frame finishes, the inversion control signal RVS applied to the data driver 500 is controlled such that the polarity of the data voltages is reversed, which is referred to as “frame inversion”. The inversion control signal RVS may be also controlled such that the polarity of the image data signals flowing in a data line are periodically reversed during one frame, for example, row inversion and dot inversion, or the polarity of the image data signals in one packet are reversed, for example, column inversion and dot inversion.

Among the above-described inversion types, the dot inversion, etc., reverses the polarities of the data voltages of adjacent data lines and repeatedly reverses the polarity of each data line between the positive and the negative. In FIG. 3, the data voltages of the left and right data lines 171 may have positive polarity, while the data voltage of the middle data line 171 may have negative polarity. However, their polarity will be reversed and the reverse of the polarity will be repeated.

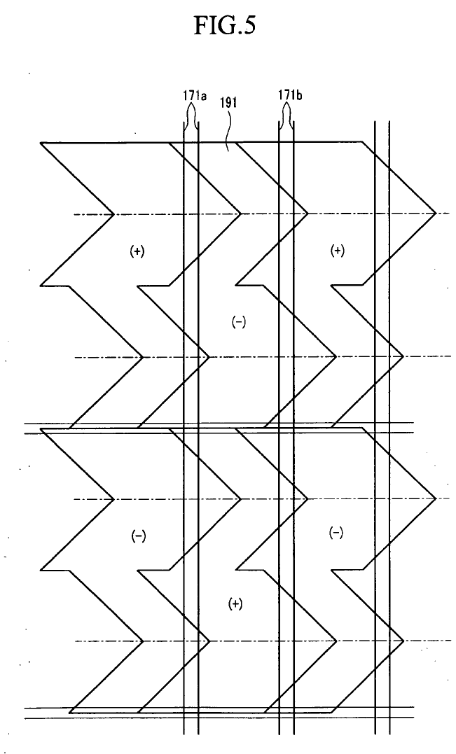

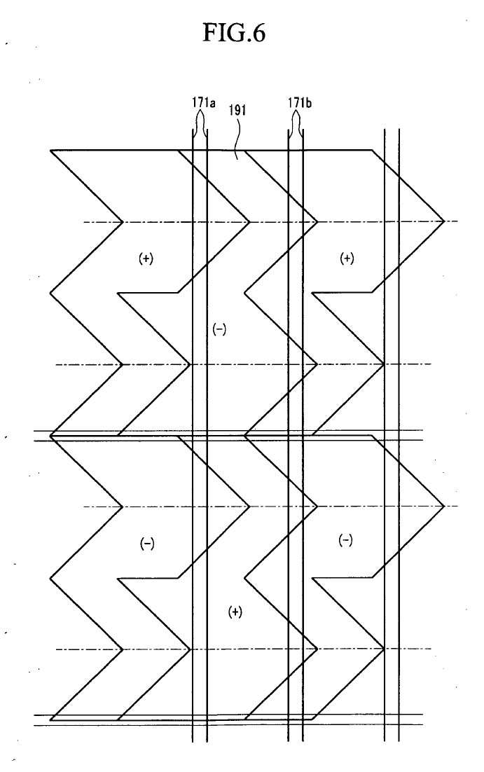

Parasitic capacitances in LCDs according to embodiments of the present invention will be described in detail with reference to FIGS. 5 and 6.

FIGS. 5 and 6 schematically show pixel electrodes and data lines according to embodiments of the present invention.

A pixel electrode 191 and a data line 171a or 171b adjacent thereto form a parasitic capacitance that varies the voltage of the pixel electrode 191. For examples, the voltage of the pixel electrode 191 rises as the voltage of the data line 171a or 171b rises, while the voltage of the pixel electrode 191 drops as the voltage of the data line 171a or 171b drops. When the voltage of the data line 171a or 171b changes from the negative polarity to the positive polarity, the voltage of the pixel electrode 191 increases. When the voltage of the data line 171a or 171b changes from the positive polarity to the negative polarity, the voltage of the pixel electrode 191 decreases. Since a pixel electrode 191 overlaps two data lines 171a and 171b having opposite polarity voltages as shown in FIGS. 5 and 6, the parasitic capacitance between the pixel electrodes 191 and one of the two data lines 171a and 171b raises the voltage of the pixel electrode 191, while the parasitic capacitance between the pixel electrode 191 and the other of the data lines 171b and 171a lowers the voltage of the pixel electrode 191.

The voltage variation of the pixel electrode 191 depends on the parasitic capacitance between the pixel electrode 191 and the data line 171a or 171b, and the parasitic capacitance is proportional to an overlapping area between the pixel electrode 191 and the data line 171a or 171b.

Although each of the pixel electrodes 191 shown in FIGS. 5 and 6 overlaps two data lines 171a and 171b, the overlapping areas between the pixel electrode 191 and each of the two data lines 171a and 171b are substantially similar in FIG. 5, wherein in FIG. 6, the overlapping areas between the pixel electrodes 191 and each of the data lines 171a and 171b may be different between the pixel electrodes 191.

Cdp1 denotes the parasitic capacitance between a pixel electrode 191 and a data line 171a and Cdp2 denotes the parasitic capacitance between the pixel electrode 191 and another data line 171b. It is assumed that the voltages of the data lines 171a and 171b are V1 and V2, respectively, when the pixel electrode 191 is supplied with a voltage Vp. The amount Qp of the electrical charge stored in the pixel electrode 191 may be determined as,
Qp=Cst×(Vp−Voff)+Clc×(Vp−Vcom)+Cdp1×(Vp−V1)+Cdp2×(Vp−V2), (1)
where Voff is the initial voltage of the pixel electrode 191.

If the voltage of the pixel electrode 191 is changed from Vp into Vp′ when the voltages of the data lines 171a and 171b are changed from V1 and V2 into V1′ and V2′, respectively, the amount Qp′ of the electrical charge stored in the pixel electrode 191 may be determined as,
Qp′=Cst×(Vp′−Voff)+Clc×(Vp′−Vcom)+Cdp1×(Vp′−V1′)+Cdp2×(Vp′−V2′). (2)

Since Qp′ is equal to Qp from the charge conservation rule, the variation Δ Vp of the voltage of the pixel electrode 191 may be determined as,

$$Δ Vp = {Vp}^{′} - Vp = \frac{Cdp 1 ( V {1}^{′} - V 1 ) + Cdp 2 ( V {2}^{′} - V 2 )}{Cst + Clc + Cdp 1 + Cdp 2} . \qquad ( 3 )$$

The voltage variation Δ Vp caused by the difference in the parasitic capacitances between the pixel electrode 191 and the data lines 171a and 171b may cause vertical cross-talk.

When the LCD employs dot inversion, but not column inversion, the temporal average of the voltage variation Δ Vp of the pixel electrode 191 in a frame is substantially zero (0) as not to generate defects. The voltage flowing in each of the data lines 171a and 171b may be changed by the difference of the parasitic capacitances. Accordingly, it is preferable that the parasitic capacitances exerted on the two data lines 171a and 171b are substantially equal to each other.

The layouts shown in FIGS. 5 and 6, where the data lines 171a and 171b are rectilinear and arranged in a substantially constant distance, can yield a vanishing temporal average of the voltage variation in a frame although there is a slight difference in the parasitic capacitance caused by the difference in the overlapping areas between the pixel electrode 191 and the data lines 171a and 171b. Therefore, the voltage rise and the voltage drop caused by the parasitic capacitances are substantially cancelled reducing the voltage variation of the pixel electrode 191.

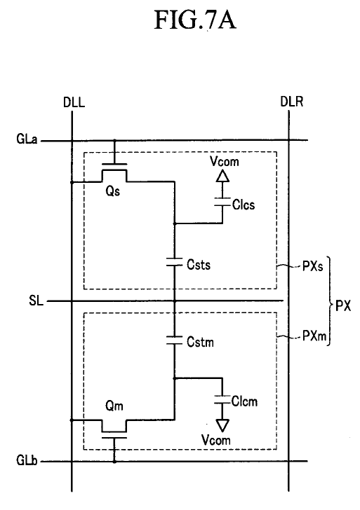

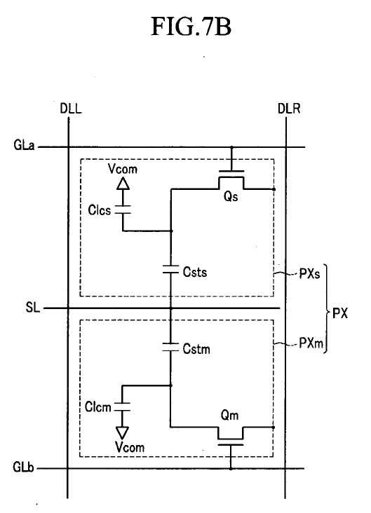

Now, a structure of an LC panel assembly according to an embodiment of the present invention will be described in detail with reference to FIGS. 7A, 7B, 8, 9 and 10 as well as FIGS. 1-3.

FIGS. 7A and 7B are equivalent circuit diagrams of signal lines and a pixel.

Each of the LC panel assemblies shown in FIGS. 7A and 7B includes a plurality of signal lines and a plurality of pixels PX connected thereto. The signal lines include a plurality of pairs of gate lines GLa and GLb, a plurality of data lines DLL and DLR, and a plurality of storage electrode lines SL extending substantially parallel to the gate lines GLa and GLb.

Each pixel PX includes a pair of subpixels PXm and PXs. Each subpixel PXm/PXs includes a switching element Qm/Qs connected to one of the gate lines GLa and GLb and one of the data lines DLL and DLR, an LC capacitor Clcm/Clcs coupled to the switching element Qm/Qs, and a storage capacitor Cstm/Csts connected between the switching element Qm/Qs and the storage electrode line SL.

The switching element Qm/Qs, such as a thin film transistor (TFT), is provided on the lower panel 100 and has a control terminal connected to a gate line GLa/GLb, an input terminal connected to a data line DLL or DLR, and an output terminal connected to the LC capacitor Clcm/Clcs and the storage capacitor Cstm/Csts. The switching elements Qm and Qs shown in FIG. 7A are connected to the same data line DLL, while the switching elements Qm and Qs are connected to different data lines DLL and DLR.

The storage capacitor Cstm/Csts is an auxiliary capacitor for the LC capacitor Clcm/Clcs. The storage capacitor Cstm/Csts includes a subpixel electrode and a separate signal line, which is provided on the lower panel 100, overlapping the subpixel electrode via an insulator, and is supplied with a predetermined voltage such as the common voltage Vcom. Alternatively, the storage capacitor Cstm/Csts includes the subpixel electrode and an adjacent gate line called a previous gate line, which overlaps the pixel electrode PEm/PEs via an insulator.

The LC capacitor Clcm/Clcs, etc., are described above with reference to FIG. 2, and the detailed description thereof will be omitted here.

In the LCD shown in FIGS. 7A and 7B, the signal controller 600 receives input image data R, G and B and converts each input image data R, G and B for each pixel into a plurality of output image data DAT for two subpixels PXm and PXs to be supplied to the data driver. Otherwise, the gray voltage generator 700 generates separate groups of gray voltages for two subpixels PXm and PXs. The two groups of gray voltages are alternately supplied by the gray voltage generator 700 to the data driver 500 or alternately selected by the data driver 500 such that the two subpixels PXm and PXs are supplied with different voltages.

The values of the converted output image signals and the values of the gray voltages in each group are preferably determined such that the synthesis of gamma curves for the two subpixels PXm and PXs approaches a reference gamma curve at a front view. For example, the synthesized gamma curve at a front view coincides with the most suitable reference gamma curve at a front view, and the synthesized gamma curve at a lateral view is the most similar to the reference gamma curve at a front view.

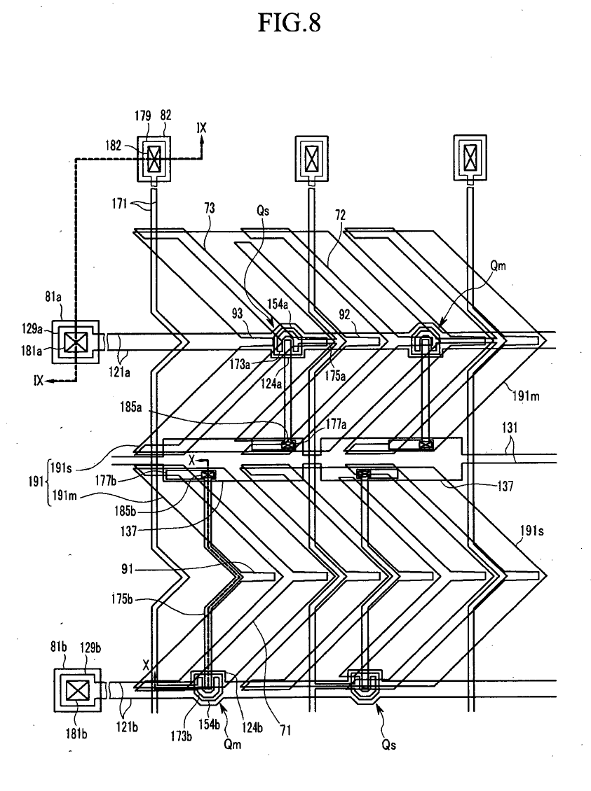

An example of an LC panel assembly shown in FIG. 7B according to an embodiment of the present invention will be described in detail with reference to FIGS. 8, 9 and 10.

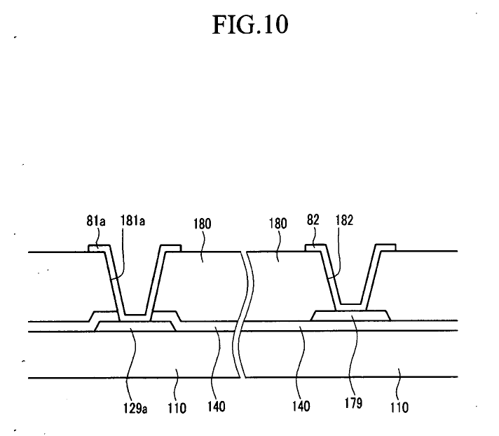

FIG. 8 is a layout view of an LC panel assembly according to an embodiment of the present invention, and FIGS. 9 and 10 are sectional views of the LC panel assembly shown in FIG. 8 taken along lines IX-IX and X-X, respectively.

Referring to FIGS. 8-10, an LC panel assembly according to an embodiment of the present invention includes a lower panel 100, an upper panel 200 facing the lower panel 100, and an LC layer 3 interposed between the panels 100 and 200.

With reference to the lower panel 100, a plurality of gate conductors including a plurality of pairs of upper and lower gate lines 121a and 121b and a plurality of storage electrode lines 131 are formed on an insulating substrate 110 such as transparent glass or plastic.

The gate lines 121a and 121b transmit gate signals, extend substantially in a transverse direction, and are disposed at relatively upper and lower positions, respectively.

Each of the upper gate lines 121a includes a plurality of upper gate electrodes 124a projecting downward and an end portion 129a having a large area for contact with another layer or an external driving circuit. Each of the lower gate lines 121b includes a plurality of lower gate electrodes 124b projecting toward upward and an end portion 129b having a large area for contact with another layer or an external driving circuit. The gate lines 121a and 121b may extend to be connected to a gate driver 400 that may be integrated on the substrate 110.

The storage electrode lines 131 are supplied with a predetermined voltage such as the common voltage Vcom and extend substantially parallel to the gate lines 121a and 121b. Each of the storage electrode lines 131 is disposed between a pair of an upper gate line 121a and a lower gate line 121b. The storage electrode line 131 is closer to the upper gate line 121a than the lower gate line 121b. The storage electrode line 131 includes a plurality of storage electrodes 137 extending upward and downward. The storage electrode lines 131 may have various shapes and arrangements.

The gate conductors 121a, 121b and 131 may be made of aluminum (Al) containing metal such as Al and Al alloy, silver (Ag) containing metal such as Ag and Ag alloy, copper (Cu) containing metal such as Cu and Cu alloy, molybdenum (Mo) containing metal such as Mo and Mo alloy, chromium (Cr), tantalum (Ta), or titanium (Ti). They may have a multi-layered structure including two conductive films (not shown) having different physical characteristics. One of the two films may be made of low resistivity metal including Al containing metal, Ag containing metal, and Cu containing metal for reducing signal delay or voltage drop. The other film may be made of material such as Mo containing metal, Cr, Ta, or Ti, which has good physical, chemical, and electrical contact characteristics with other materials such as indium tin oxide (ITO) or indium zinc oxide (IZO). Good examples of the combination of the two films are a lower Cr film and an upper Al (alloy) film and a lower Al (alloy) film and an upper Mo (alloy) film. The gate conductors 121a, 121b and 131 may be made of various metals or conductors.

The lateral sides of the gate conductors 121a, 121b and 131 are inclined relative to a surface of the substrate, and the inclination angle thereof ranges about 30-80 degrees.

A gate insulating layer 140 that may be made of silicon nitride (SiNx) or silicon oxide (SiOx) is formed on the gate conductors 121a, 121b and 131.

A plurality of pairs of upper and lower semiconductor islands 154a and 154b that may be made of hydrogenated amorphous silicon (abbreviated to “a-Si”) or polysilicon are formed on the gate insulating layer 140. The upper/lower semiconductor islands 154a/154b are disposed on the upper/lower gate electrodes 124a/124b.

A plurality of pairs of ohmic contact islands 163b and 165b are formed on the lower semiconductor islands 154b, and a plurality of pairs of ohmic contact islands (not shown) are formed on the upper semiconductor islands 154a. The ohmic contact islands 163b and 165b may be made of n+hydrogenated a-Si (silicon) heavily doped with n type impurity such as phosphorous or they may be made of silicide.

The lateral sides of the semiconductor islands 154a and 154b and the ohmic contacts 163b and 165b are inclined relative to the surface of the substrate 110, and the inclination angles thereof may be in a range of about 30-80 degrees.

A plurality of data conductors including a plurality of data lines 171 and a plurality of pairs of upper and lower drain electrodes 175a and 175b are formed on the ohmic contacts 163b and 165b and the gate insulating layer 140.

The data lines 171 transmit data signals and extend substantially in the longitudinal direction to intersect the gate lines 121a and 121b and the storage electrode lines 131. The data lines 171 have bent portions and each of the bent portions includes two oblique portions connected to each other with making about a right angle. Each of the data line 171 includes a plurality of upper and lower source electrodes 173a and 173b projecting toward the upper and the lower gate electrodes 124a and 124b, respectively, and curved like a character U. Each of the data line 171 further includes an end portion 179 having an area for contact with another layer or an external driving circuit. The data lines 171 may extend to be connected to a data driver 500 that may be integrated on the substrate 110.

The upper and the lower drain electrodes 175a and 175b are separated from each other and separated from the data lines 171. The upper/lower drain electrodes 175a/175b are disposed opposite the upper/lower source electrodes 173a/173b with respect to the upper/lower gate electrodes 124a/124b.

Each of the upper drain electrodes 175a extends downward from an end thereof enclosed by an upper source electrode 173a, and includes an expansion 177a extending left and right on along a storage electrode 137. Each of the lower drain electrodes 175b extends upward from an end thereof enclosed by a lower source electrode 173b, and includes an expansion 177b extending left and right on a storage electrode 137. Each of the lower drain electrodes 175b includes a bent portion including two oblique portions connected to each other with making about a right angle, and the distance between adjacent data lines 171 is substantially uniform.

An upper/lower gate electrode 124a/124b, an upper/lower source electrode 173a/173b, and an upper/lower drain electrode 175a/175b along with an upper/lower semiconductor island 154a/154b form a TFT Qm or Qs having a channel formed in the upper/lower semiconductor island 154a/154b disposed between the upper/lower source electrode 173a/173b and the upper/lower drain electrode 175a/175b.

The data conductors 171, 175a and 175b may be made of refractory metal such as Cr, Mo, Ta, Ti, or alloys thereof. However, they may have a multilayered structure including a refractory metal film (not shown) and a low resistivity film (not shown). Good examples of the multi-layered structure are a double-layered structure including a lower Cr/Mo (alloy) film and an upper Al (alloy) film and a triple-layered structure of a lower Mo (alloy) film, an intermediate Al (alloy) film, and an upper Mo (alloy) film. The data conductors 171, 175a and 175b may be made of various metals or conductors.

The data conductors 171, 175a and 175b have inclined edge profiles, and the inclination angles thereof range about 30-80 degrees.

The ohmic contacts 163b and 165b are interposed only between the underlying semiconductor islands 154a and 154b and the overlying data conductors 171, 175a and 175b thereon and reduce the contact resistance therebetween. The semiconductor islands 154a and 154b include some exposed portions, which are not covered with the data conductors 171, 175a and 175b, such as portions located between the source electrodes 173a and 173b and the drain electrodes 175a and 175b.

A passivation layer 180 is formed on the data conductors 171, 175a and 175b and the exposed portions of the semiconductor islands 154a and 154b. The passivation layer 180 may be made of organic insulator having a low dielectric constant so that the passivation layer 180 can have a large thickness. The passivation layer 180 may have a flat top surface and may have photosensitivity. The passivation layer 180 may be made of inorganic insulator, or may include a lower film of inorganic insulator and an upper film of organic insulator such that it takes the excellent insulating characteristics of the organic insulator while substantially preventing the exposed portions of the semiconductor islands 154a and 154b from being damaged by the organic insulator.

The passivation layer 180 has a plurality of contact holes 182 exposing the end portions 179 of the data lines 171, a plurality of contact holes 185a exposing the expansions 177a of the upper drain electrodes 175a, and a plurality of contact holes 185b exposing the expansions 177b of the lower drain electrodes 175b. The passivation layer 180 and the gate insulating layer 140 have a plurality of contact holes 181a and 181b exposing the end portions 129a and 129b of the gate lines 121a and 121b.

A pixel electrode 191 and a plurality of contact assistants 81a, 81b and 82 are formed on the passivation layer 180. They may be made of transparent conductor such as ITO or IZO or reflective conductor such as Ag, Al, Cr, or alloys thereof.

Each of the pixel electrodes 191 includes a pair of first and second subpixel electrodes 191m and 191s. The first subpixel electrode 191m has a cutout 91, and the second subpixel electrode 191s has cutouts 92 and 93.

Each of the subpixel electrodes 191m and 191s is physically and electrically connected to a drain electrode 175a or 175b through a contact hole 185a or 185b.

The storage electrode lines 131, the expansions 177a and 177b of the drain electrodes 175a and 175b, and the contact holes 185a and 185b are disposed near boundaries between the first subpixel electrodes 191m and the lower subpixel electrodes 191s. Similarly, the lower gate lines 121b are disposed near boundaries between the pixel electrodes 191, and the upper gate lines 121a lie on straight lines connecting bent points of the subpixel electrodes 191m and 191s. The lines connecting the bent points of the subpixel electrodes 191m and 191s and the boundaries of the first and the second subpixel electrodes 191m and 191s form boundaries of the above-described sub-areas, and cover texture that may be generated by the disorder of the LC molecules near the boundaries of the sub-areas, thereby improving the aperture ratio.

Features of the pixel 191 described above with reference to FIGS. 3 and 4 are omitted from the detailed description here.

A subpixel electrode 191m or 191s and the common electrode 270 along with a portion of the LC layer 3 disposed therebetween form an LC capacitor Clcm or Clcs, which stores applied voltages after the TFT Qm or Qs turns off.

Each of the subpixel electrodes 191m and 191s and a drain electrode 175a or 175b connected thereto overlap a storage electrode line 131 including a storage electrode 137 with the gate insulating layer 140 interposed therebetween to form a storage capacitor Cstm or Csts. The storage capacitors Cstm and Csts improve the charge storing capacity of the LC capacitors Clcm and Clcs.

The parasitic capacitance between the pixel electrodes 191 and the data lines 171 is low although the pixel electrodes 191 and the data lines 171 overlap each other since the passivation layer 180 is thick and has a low dielectric constant.

The contact assistants 81a, 81b and 82 are connected to the end portions 129a and 129b of the gate lines 121a and 121b and the end portions 179 of the data lines 171 through the contact holes 181a, 181b and 182, respectively. The contact assistants 81a, 81b and 82 protect the end portions 129a, 129b and 179 and improve the adhesion between the end portions 129a, 129b and 179 and external devices.

With reference to the upper panel 200, a light blocking member 220 is formed on an insulating substrate 210 such as transparent glass or plastic. The light blocking member 220 may include bent portions (not shown) facing the bent edges of the pixel electrode 191 on the lower panel 100 and widened portions (not shown) facing the TFTs Qm and Qs on the lower panel 100. The light blocking member 220 preventing light leakage near the boundaries of the pixel electrode 191. The light blocking member 220 may have other various shapes.

A plurality of color filters 230 are also formed on the substrate 210 and the light blocking member 220, and the color filters 230 are disposed substantially in the area enclosed by the light blocking member 220. The color filters 230 may extend substantially in the longitudinal direction along the pixel electrodes 191. The color filters 230 may represent one of primary colors such as red, green, and blue colors.

An overcoat 250 is formed on the color filters 230 and the light blocking member 220. The overcoat 250 may be made of (organic) insulator and it prevents the color filters 230 from being exposed and provides a flat surface. The overcoat 250 may be omitted.

A common electrode 270 is formed on the overcoat 250. The common electrode 270 may be made of transparent conductive material such as ITO and IZO and has a plurality of cutouts 71, 72 and 73, which are described above with reference to FIG. 3.

The number of the cutouts 71-73 may be varied depending on design factors, and the light blocking member 220 may also overlap the cutouts 71-73 to block the light leakage near the cutouts 71-73.

Alignment layers 11 and 21 that may be homeotropic are coated on inner surfaces of the panels 100 and 200.

Polarizers 12 and 22 are provided on outer surfaces of the panels 100 and 200 so that their polarization axes may be crossed and the polarization axes may make about 45 degree angles with the bent edges of the subpixel electrodes 191m and 191s for increasing light efficiency. One of the polarizers 12 and 22 may be omitted when the LCD is a reflective LCD.

The LCD may further include a backlight unit (not shown) supplying light to the LC layer 3 through the polarizers 12 and 22, and the panels 100 and 200.

It is preferable that the LC layer 3 has negative dielectric anisotropy and it is subjected to a vertical alignment.

The shapes and the arrangements of the cutouts 71a, 72b, 73b, 92b and 93b may be modified.

At least one of the cutouts 71-73 and 91-93 can be substituted with protrusions (not shown) or depressions (not shown). The protrusions may be made of organic or inorganic material and disposed on or under the field generating electrode 191 or 270.

The bent portions of the data lines 171 and the lower drain electrodes 175b overlap the cutouts 92 of the pixel electrodes 191, the cutouts 71-73 of the common electrode 270, or gaps between the pixel electrodes 191.

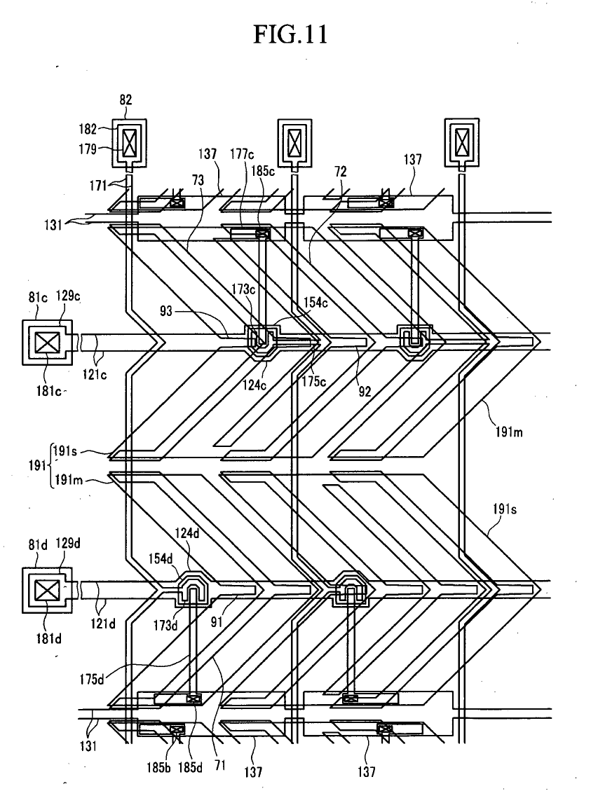

Another example of an LC panel assembly shown in FIG. 7B. according to an embodiment of the present invention will be described in detail with reference to FIG. 11.

FIG. 11 is a layout view of an LC panel assembly according to another embodiment of the present invention.

Referring to FIG. 11, an LC panel assembly according to an embodiment of the present invention includes a lower panel (not shown), an upper panel (not shown) facing the lower panel, an LC layer (not shown), and a pair of polarizers (not shown).

Layered structures of the LC panel assembly according to this embodiment are almost the same as those shown in FIGS. 9 and 10.

Regarding the lower panel, gate conductors including a plurality of pairs of upper and lower gate lines 121c and 121d and a plurality of storage electrode lines 131 are formed on a substrate (not shown). Each of the upper/lower gate lines 121c/121d includes upper/lower gate electrodes 124c/124d and an end portion 129c/129d. The storage electrode lines 131 include storage electrodes 137. A gate insulating layer (not shown) is formed on the gate conductors 121c, 121d and 131, and a plurality of pairs of semiconductor islands 154c and 154d are formed on the gate insulating layer. A plurality of pairs of ohmic contact islands (not shown) are formed on the semiconductor islands 154c and 154d. Data conductors including a plurality of data lines 171 and a plurality of pairs of upper and lower drain electrodes 175c and 175d are formed on the ohmic contacts and the gate insulating layer. Each of the data lines 171 include a plurality of upper and lower source electrodes 173c and 173d and an end portion 179. The drain electrodes 175c and 175d include expansion 177c and 177d. A passivation layer (not shown) is formed on the data conductors 171, 175c and 175d, the gate insulating layer, and exposed portions of the semiconductor islands 154c and 154d. A plurality of contact holes 181c, 181d, 182, 185c, and 185d are provided at the passivation layer and the gate insulating layer. A pixel electrode 191 including first and second subpixel electrodes 191m and 191s, and a plurality of contact assistants 81a, 81b and 82 are formed on the passivation layer. The first and second subpixel electrodes 191c and 191d have cutouts 91, 92 and 93. An alignment layer 11 is formed on the pixel electrodes 191 and the passivation layer.

Regarding the upper panel, a light blocking member (not shown), a color filter (not shown), an overcoat (not shown), a common electrode (not shown) having a plurality of cutouts 71, 72 and 73, and an alignment layer (not shown) are formed on an insulating substrate.

The lower gate lines 121b are disposed on the straight lines connecting the bent points of the subpixel electrodes 191m and 191s, and the storage electrode lines 131 are disposed near the boundaries of the pixel electrodes 191. Each of the storage electrodes 137 overlaps the drain electrodes 175c and 175d in different pixels.

Embodiments of the LC panel assembly described with reference to FIGS. 8-10 may be applicable to the LC panel assembly shown in FIG. 11.

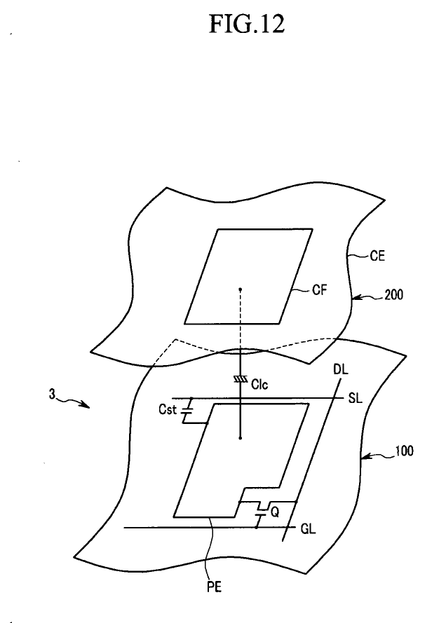

A structure of an LC panel assembly according to another embodiment of the present invention will be described in detail with reference to FIGS. 12, 13, 14, 15, 16 and 17.

FIG. 12 is an equivalent circuit diagram of signal lines and a pixel according to another embodiment of the present invention.

The LC panel assembly shown in FIG. 12 includes a lower panel 100, an upper panel 200 facing the lower panel 200, and an LC layer 3 disposed between the panels 100 and 200.

A plurality of signal lines including gate lines GL, data lines DL, and storage electrode lines SL are formed on the lower panel 100. Each pixel includes a switching element Q connected to one of the gate lines GL and one of the data lines DL, an LC capacitor Clc coupled to the switching element Q, and a storage capacitor Cst connected between the switching element Q and the storage electrode line SL.

The switching element Qc/Qd such as a thin film transistor (TFT) is provided on the lower panel 100 and has a control terminal connected to a gate line GL, an input terminal connected to a data line DL, and an output terminal connected to the LC capacitor Clc and the storage capacitor Cst.

The LC capacitor Clc includes a pixel electrode PE and a common electrode CE provided on an upper panel 200 as two terminals. The LC layer 3 disposed between the electrodes PE and CE functions as dielectric of the LC capacitor Clc. The common electrode CE is supplied with a common voltage Vcom and covers an entire surface of the upper panel 200. The LC layer 3 has negative dielectric anisotropy, and LC molecules in the LC layer 3 may be oriented so that long axes of the LC molecules are perpendicular to the surfaces of the panels 100 and 200 in absence of electric field.

The storage capacitor Cst and the operation of the LCD including the panel assembly shown in FIG. 12, etc., are substantially the same as those described above, and detailed description thereof will be omitted. It is noted that a pixel PX is not divided into two subpixels.

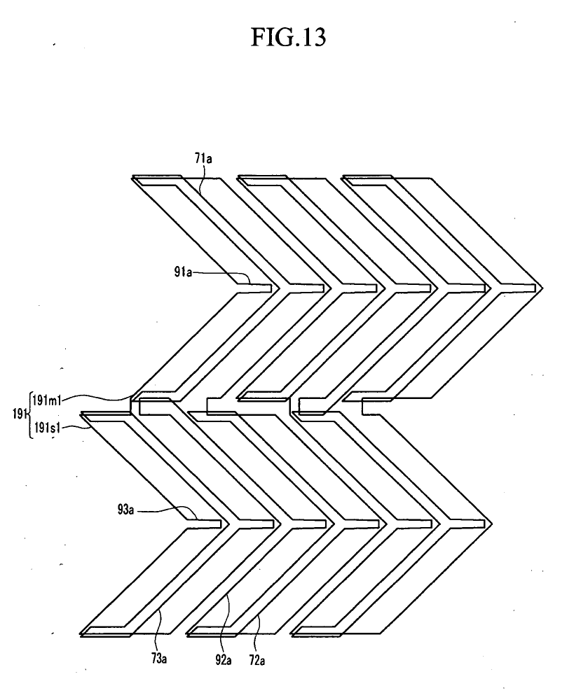

Examples of pixel electrodes and common electrodes in an LC panel assembly shown in FIG. 12 according to embodiments of the present invention will be described in detail with reference to FIGS. 13, 14 and 15.

FIGS. 13, 14 and 15 are layout views of pixel electrodes and cutouts of LC panel assemblies according to embodiments of the present invention.

Referring to FIGS. 13-15, each pixel electrode 191 includes a first subpixel electrode 191m1, 191m2 or 191m3 and a second subpixel electrode 191s1, 191s2 or 191s3 and has substantially the same planar shape as the pixel electrode 191 shown in FIG. 3. Each of the first and the second subpixel electrodes 191m1-191m3 and 191s1-191s3 includes a base electrode (shown in FIG. 4) or two base electrodes adjacent in the row direction. The first and the second subpixel electrodes 191m1-191m3 and 191s1-119s3 have cutouts 91a-93a, 91b-93b and 91c-93c, and the common electrode CE has cutouts 71a-73a, 71b-73b and 71c-73c facing the first and the second subpixel electrodes 191m1-191m3 and 191s1-191s3.

Two subpixel electrodes 191m1-191m3 and 191s1-191s3 of each pixel electrode 191 shown in FIGS. 13-15 are connected to each other to have the same voltage.

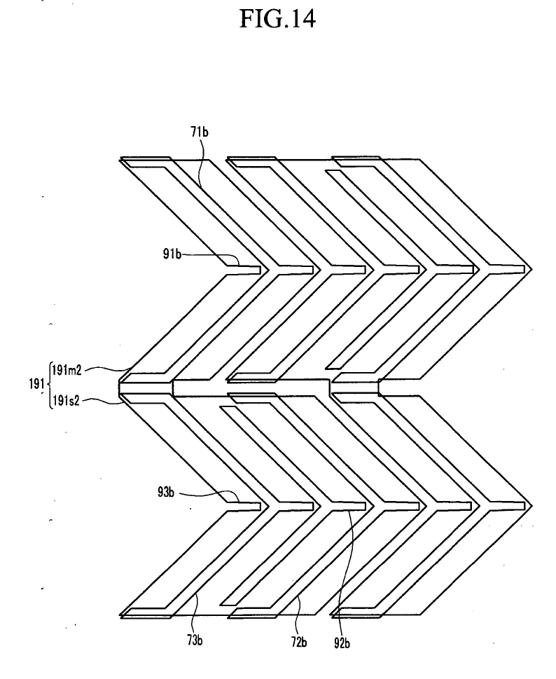

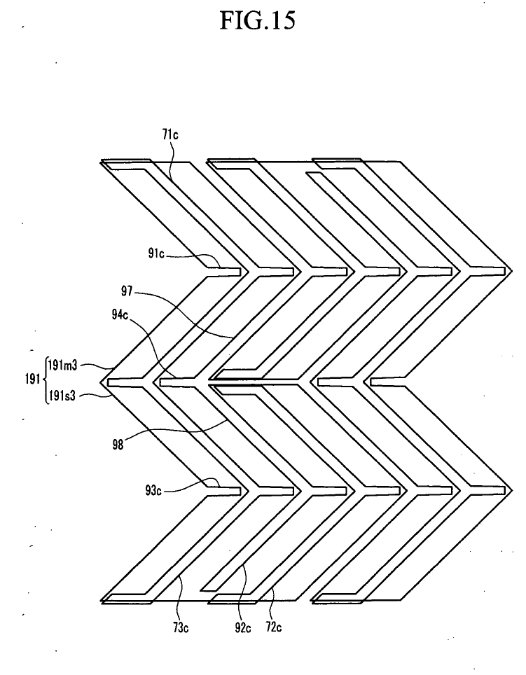

Describing the arrangement of the subpixel electrodes 191m1-191m3 and 191s1-191s3 prior to the description of the connection between the first subpixel electrode 191ml-191m3 and the second subpixel electrode 191s1-191s3, the concave edges (left edges) and the convex edges (right edges) of the first subpixel electrodes 191m2 and 191m3 and the second subpixel electrodes 191s2 and 191s3 shown in FIGS. 14 and 15 are alternately aligned along the row direction. Referring to FIG. 13, the first subpixel electrode 191ml is substantially aligned with a center of the second subpixel electrode 191s1. The example shown in FIG. 13 the bent portion of the cutout 71a bisecting the first subpixel electrode 191m1 nearly overlap the bent portion of the cutout 92a bisecting the second subpixel electrode 191s1. Furthermore, the convex edge and the concave edge of the first subpixel electrode 191m1 nearly overlap the bent portions of the cutouts 72a and 73a bisecting the base electrodes of the second subpixel electrode 191s1. In other words, the bent edges of the subpixel electrodes 191m1 and 191s1 or the bent portions of the cutouts 92a in a subpixel row nearly overlap the bent portions of the cutouts 71a-73a of the common electrode 270 in a subpixel row adjacent thereto.

Referring to FIGS. 13-15, when the first subpixel electrode 191ml-19m3 and the second subpixel electrode 191s1-191s3 arranged in the column direction are connected to each other, a portion or portions, but not all portions, of a transverse edge of the first subpixel electrode 191m1-191m3 are connected to the second subpixel electrode 191s1-191s3. This configuration reduces the occurrence of textures near boundaries of the first subpixel electrode 191m1-191m3 and the second subpixel electrode 191s1-191s3.

Referring to FIG. 13, the cutout 92a disposed between two base electrodes of the second subpixel electrode 191s1 are connected to upper and lower transverse edges of the second subpixel electrode 191s1, and in particular, a portion of a gap between the first subpixel electrode 191m1 and the second subpixel electrode 191s1 forms a terminal transverse portion of the cutout 92a. A portion where the convex edge of the first subpixel electrode 191m1 meets the transverse edge the second subpixel electrode 191s1 at an acute angle is recessed.

Referring to FIG. 14, only about a half of the transverse portion of the first subpixel electrode 191m2 is connected to the second subpixel electrode 191s2. A portion where the convex edge of the first subpixel electrode 191m2 meets the transverse edge the second subpixel electrode 191s2 at an acute angle, or a portion where the convex edge of the first subpixel electrode 191m2 meets the convex edge of the second subpixel electrode 191s2 at about a right angle is recessed.

Referring to FIG. 15, the connection between the first subpixel electrode 191m3 and a base electrode of the second subpixel electrode 191s3 and the connection between the cutouts 71c and 73c leave no opening and form a character W. In detail, a lower oblique edge of the concave edge of the second subpixel electrode 191s3 and an upper oblique edge of the concave edge in the left base electrode of the second subpixel electrode 191s3 meet each other at about a right angle to form a convex edge. Similarly, a lower oblique edge 97 of the convex edge of the second subpixel electrode 191s3 and an upper oblique edge 98 of the convex edge in the left base electrode of the second subpixel electrode 191s3 meet each other at about a right angle to form a concave edge. A transverse cutout 94c is formed in the pixel electrode 191, which starts from a concave vertex of the concave edge and extends inward with a decreasing width. Two transverse edges of the cutout 94c meet the oblique edges 97 and 98 at an angle greater than about 135 degrees such that the orientations of the liquid crystal molecules are further stabilized.

In addition, when the two cutouts 71c and 73c of the common electrode 270, as shown in FIG. 15, are connected to each other, adjacent terminal transverse portions of the two cutouts 71c and 73c are united into one. The cutout 92c disposed between two base electrodes of the second subpixel electrode 191s3 meets an upper transverse edge of the second subpixel electrode 191s3.

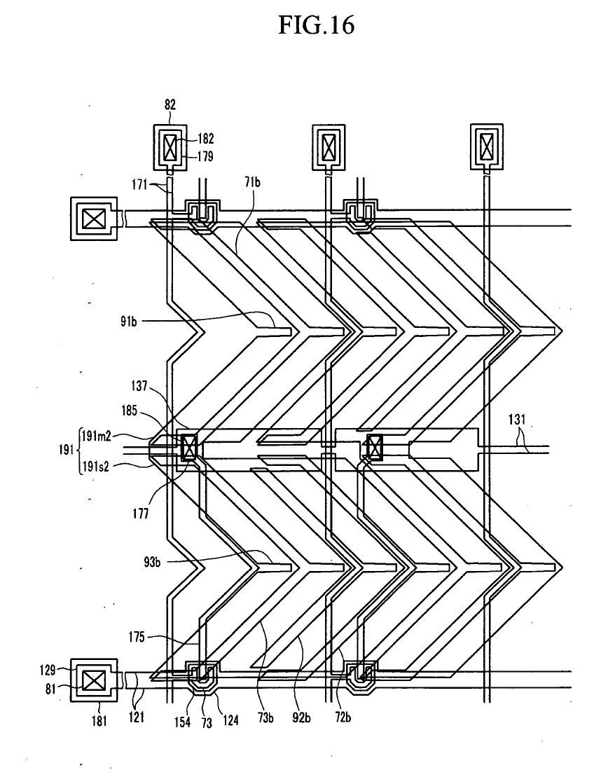

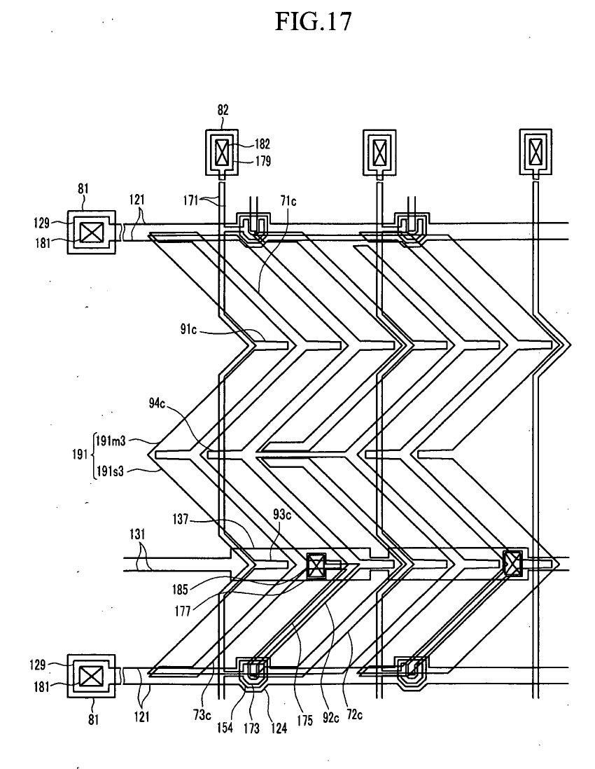

Examples of an LC panel assembly shown in FIG. 12 according to embodiments of the present invention will be described in detail with reference to FIGS. 16 and 17 as well as FIGS. 14 and 15.

FIGS. 16 and 17 are layout views of an LC panel assembly according to embodiments of the present invention.

Referring to FIGS. 16 and 17, an LC panel assembly includes a lower panel (not shown), an upper panel (not shown) facing the lower panel, and an LC layer (not shown) disposed between the panels.

Layered structures of the LC panel assembly according to these embodiments are almost the same as those shown in FIGS. 8-10.

Regarding the lower panel, a plurality of gate conductors including gate lines 121 and storage electrode lines 131 are formed on a substrate (not shown). Each of the gate lines 121 includes gate electrodes 124 and an end portion 129, and the storage electrode line 131 includes storage electrodes 137. A gate insulating layer (not shown) is formed on the gate conductors 121 and 131. A plurality of semiconductor islands 154 are formed on the gate insulating layer, and a plurality of ohmic contacts (not shown) are formed on the semiconductor islands 154. A plurality of data conductors including a plurality of data lines 171 and a plurality of drain electrodes 175 are formed on the ohmic contacts and the gate insulating layer. Each of the data lines 171 includes a plurality of source electrodes 173 and an end portion 179, and each of the drain electrodes 175 includes a wide end portion 177. A passivation layer is formed on the data conductors 171 and 175, the gate insulating layer, and exposed portions of the semiconductor islands 154. A plurality of contact holes 181, 182 and 185 are provided at the passivation layer and the gate insulating layer. A plurality of pixel electrodes 191 including first and second subpixel electrodes 191m2 and 191s2 or 191m3 and 191s3 and a plurality of contact assistants 81 and 82 are formed on the passivation layer. An alignment layer (not shown) is formed on the pixel electrodes 191 and the passivation layer 180.

Regarding the upper panel, a light blocking member (not shown), a plurality of color filters (not shown), an overcoat (not shown), a common electrode having a plurality of cutouts 71b, 72b and 73b, or 71c, 72c and 73c, and an alignment layer (not shown) are formed on an insulating substrate (not shown).

The pixel electrodes 191 and the cutouts 71b-73b shown in FIG. 16 have substantially the same shape as those shown in FIG. 14, and the pixel electrodes 191 and the cutouts 71c-73c shown in FIG. 17 have substantially the same shape as those shown in FIG. 15. The first and the second subpixel electrodes 191m2 and 191s2 or 191m3 and 191s3 of each pixel electrode 191 are electrically coupled to each other to have the same voltage, and the pixel electrodes 191 have cutouts 91b-93b or 91c-94c.

Each pixel electrode 191 is coupled to only one TFT and thus the number of the gate lines 191 shown in FIGS. 16 and 17 is a half of the number of the gate lines 121a and 121b.

Referring to FIGS. 16 and 17, the gate lines 121 are disposed near boundaries of the pixel electrodes 191 adjacent in the column direction. The storage electrode lines 131 shown in FIG. 16 extend along the connections between the first subpixel electrodes 191m2 and the second subpixel electrodes 191s2, while the storage electrode lines 131 shown in FIG. 17 extend along the curved points of the first and the second subpixel electrodes 191m3 and 191s3 and are disposed close to a lower edge of the pixel electrodes 191.

Embodiments of the LC panel assembly described with reference to FIGS. 8-10 may be applicable to the LC panel assemblies shown in FIGS. 16 and 17.

While the present invention has been described in detail with reference to preferred embodiments, those skilled in the art will appreciate that various modifications and substitutions can be made thereto without departing from the spirit and scope of the present invention.

What is claimed is:

1. A liquid crystal display comprising:
a substrate;
a plurality of first subpixel electrodes disposed on the substrate, each of the first subpixel electrodes having a pair of bent edges substantially parallel to each other;
a plurality of second subpixel electrodes disposed on the substrate, each of the second subpixel electrodes having a pair of bent edges substantially parallel to each other, each pair of the first and the second subpixel electrodes disposed in a first direction and forming a pixel electrode; and
a common electrode facing a plurality of pixel electrodes including the pixel electrode,
wherein the first and the second subpixel electrodes have different lengths in a second direction substantially perpendicular to the first direction.

2. The liquid crystal display of claim 1, wherein one of the bent edges of the first subpixel electrode and one of the bent edges of the second subpixel electrode in each of the pixel electrodes are aligned with each other in the first direction.

3. The liquid crystal display of claim 1, wherein a center of the first subpixel electrode and a center of the second subpixel electrode in each of the pixel electrodes are aligned with each other in the first direction.

4. The liquid crystal display of claim 1, further comprising:
a plurality of thin film transistors coupled to the pixel electrodes;
a plurality first signal lines coupled to the thin film transistors and spaced apart from each other by a substantially uniform distance in the first direction; and
a plurality of second signal lines coupled to the thin film transistors and intersecting the first signal lines.

5. The liquid crystal display of claim 4, wherein the first signal lines transmit data voltages and are rectilinear.

6. The liquid crystal display of claim 4, wherein each of the first and the second subpixel electrodes is coupled to one of the thin film transistors, and the first and the second subpixel electrodes in each of the pixel electrodes are supplied with different data voltages originated from a single image information.

7. The liquid crystal display of claim 6, wherein the first and the second subpixel electrodes in each of the pixel electrodes are supplied with respective data voltages at different times.

8. The liquid crystal display of claim 6, wherein the first and the second subpixel electrodes in each of the pixel electrodes are substantially simultaneously supplied with respective data voltages.

9. The liquid crystal display of claim 4, wherein the second signal lines one of pass through one of the first subpixel electrodes and the second subpixel electrodes, and extend along boundaries of the first subpixel electrodes and the second subpixel electrodes.

10. The liquid crystal display of claim 4, further comprising an organic layer disposed between the pixel electrodes and the thin film transistors and the first and the second signal lines.

11. The liquid crystal display of claim 1, further comprising a plurality of storage electrode lines overlapping at least one of the first subpixel electrodes and the second subpixel electrodes, wherein the plurality of storage electrode lines one of pass through one of the first and the second subpixel electrodes, and extend along boundaries of the first subpixel electrodes and the second subpixel electrodes.

12. The liquid crystal display of claim 1, wherein bent angles of the bent edges of the first and the second subpixel electrodes are substantially equal to a right angle.

13. The liquid crystal display of claim 1, wherein the first subpixel electrodes and the second subpixel electrodes have substantially the same length in the first direction.

14. The liquid crystal display of claim 13, wherein a length of the second subpixel electrodes is from about 1.8 times to about twice a length of the first subpixel electrodes in the second direction.

15. The liquid crystal display of claim 1, wherein the first subpixel electrode and the second subpixel electrode in each of the pixel electrodes are separated from each other and have separate voltages.

16. The liquid crystal display of claim 15, wherein in each of the pixel electrodes, an area of the first subpixel electrode is smaller than the second subpixel electrode, and the voltage of the first subpixel electrode is higher than the voltage of the second subpixel electrode.

17. The liquid crystal display of claim 16, wherein in each of the pixel electrodes, the area of the second subpixel electrode is from about 1.8 times to about twice the area of the first subpixel electrode.

18. The liquid crystal display of claim 17, wherein the first subpixel electrode and the second subpixel electrode in each of the pixel electrodes are supplied with separated data voltages originated from a single image information.

19. The liquid crystal display of claim 16, wherein the first subpixel electrode and the second subpixel electrode in each of the pixel electrodes are capacitively coupled to each other.

20. The liquid crystal display of claim 1, wherein the first subpixel electrode and the second subpixel electrode in each of the pixel electrodes are connected to each other.
